(19) United States
(12) Patent Application Publication
(10) Pub. No.: US 2012/0166062 A1
(43) Pub. Date: Jun. 28, 2012

(54) MOTOR VEHICLE WITH AN EXHAUST GAS RETREATMENT SYSTEM AND METHOD FOR OPERATING THE MOTOR VEHICLE

(75) Inventors: Heiko BALD, Modautal (DE); Frank BONARENS, Oberursel (DE)

(73) Assignee: GM GLOBAL TECHNOLOGY OPERATIONS LLC, Detroit, MI (US)

(21) Appl. No.: 13/338,294

(22) Filed: Dec. 28, 2011

(30) Foreign Application Priority Data
Dec. 28, 2010 (DE) 102010056399.4

(51) Int. Cl. F01N 3/00; F02D 28/00

(52) U.S. Cl. 701/102

(57) ABSTRACT

A motor vehicle includes, but is not limited to an exhaust gas retreatment system. An additive is injected into an exhaust gas flow of a combustion engine and a vehicle operation or engine start can be influenced by a control unit as a function of a filling level of the additive in an additional tank. The control unit is coupled to a knowledge database and sensors for monitoring a vehicle environment, the signals of which feed the knowledge database. The control unit accessing the data of the knowledge database influences the driving operation or engine start.

### CROSS-REFERENCE TO RELATED APPLICATION

This application claims priority to German Patent Application No. 102010056399.4, filed Dec. 28, 2010, which is incorporated herein by reference in its entirety.

### TECHNICAL FIELD

The technical field relates to a motor vehicle with an exhaust gas retreatment system. An additive is injected into an exhaust gas flow of a combustion engine and a motor vehicle operation or engine start can be influenced by a control unit as a function of a filling level of the additive in an additional tank and a method for operating a motor vehicle.

### BACKGROUND

Motor vehicles are frequently equipped with combustion engines, such as diesel engines, the exhaust gas flow of which among other things contains nitric oxides, carbon monoxide and carbon dioxide. To reduce a pollutant emission it is known to inject an additive such as urea or a urea solution in this exhaust gas flow in order to reduce the emission quantity of pollutants on a catalytic converter arranged downstream. To this end, the additive is carried along in the vehicle in a separate additional tank. This additional tank is usually filled also filled during a regular refueling operation. When the additional tank is empty, no exhaust gas retreatment can be carried out any longer and a pollutant emission increases.

DE 10 2007 059 473 A1 discloses an exhaust gas retreatment system. A filling level of an additive is monitored with one or more sensors. At a low filling level, an intervention in the operation of the motor vehicle or the combustion engine is carried out in order to increase, for example, the range of the motor vehicle to the next filling station through a slower and/or more fuel-saving driving mode. With an empty additional tank, the combustion engine can even be forcibly switched off, which, depending on the environment in which the vehicle happens to find itself, can involve major risks.

In view of the foregoing, it is desirable to provide a motor vehicle equipped in such a manner that it can be operated in a roadworthy manner even with an additional tank that is running empty. In addition, other objects, desirable features, and characteristics will become apparent from the subsequent summary and detailed description, and the appended claims, taken in conjunction with the accompanying drawings and this background.

### SUMMARY

In the case of a motor vehicle having an exhaust gas retreatment system, an additive is injected in an exhaust gas flow of a combustion engine and a vehicle operation or engine start can be influenced by a control unit as a function of a filling level of the additive in an additional tank, the control unit is coupled to a knowledge database and sensors for monitoring a vehicle environment, the signals of which feed the knowledge database, wherein the control unit influences the driving operation or engine start by means of the data of the knowledge database.

In the case of a method for operating a motor vehicle with an exhaust gas retreatment system, an additive is injected into an exhaust gas flow of a combustion engine and a vehicle operation or engine start is influenced by a control unit as a function of a filling level in an additional tank for the additive. For influencing the driving operation or engine starts, the control unit communicates with a knowledge database that is fed with signals from sensors for monitoring a vehicle environment and/or switching positions of a switch arranged in the interior of the motor vehicle.

The motor vehicle is equipped with the exhaust gas retreatment system, which for the pollutant reduction injects an additive, such as uric acid or a uric acid solution from an additional tank into the exhaust gas flow of the combustion engine. The additional tank is assigned a filling level sensor for monitoring the filling level of the additive. If for example a minimum filling level of the additive is undershot, intervention in an engine management can be carried out in the manner known per se among other things in order to combust a leaner fuel/air mixture requiring less additive for the exhaust gas retreatment. From a certain filling level of the additive in the additional tank, a combustion engine is switched off or can no longer be started. In order to avoid that starting of the combustion engine is not prevented in a critical or dangerous situation a knowledge database is connected to the decisive control unit, which in addition to permanently stored information comprises current actual information from sensors for monitoring a vehicle environment and based on the information available draws conclusions if the motor vehicle with a low filling level of the additive or missing additive is in a potentially critical situation or endangering the traffic. If this is the case, motor vehicle operation is continued in the regular mode. This means that either the additive is added in normal quantity until it is used up or, if it has already been completely used up, the combustion engine is operated without additive addition in the exhaust gas flow and the combustion engine with a stationary motor vehicle is to be restarted also if required.

Accordingly, a situation is automatically detected through the configuration of the motor vehicle or the knowledge database of the motor vehicle and the motor vehicle upon low filling level of the additive in the additional tank or upon a consumed reserve of the additive, accordingly is not operated in an economical operating state or a starting of the combustion engine even prevented. Through this it is avoided on the one hand that the motor vehicle is shut down for example on a level crossing because of missing additive and on the other hand the acceptance of the additional equipment for using the additive is increased, since no direct intervention in the vehicle operation is carried out.

Practically, information of one or a plurality of image recording devices, such as for example a chip camera, is processed. With such a camera an environment of a motor vehicle can be recorded and with an associated image processing device, traffic signs on intersections and level crossings, highway on-ramps, roads without permissible parking options or other hazard locations can be automatically detected, for example. If it is determined by the knowledge database because of the evaluated image data available that the motor vehicle is located in a potentially hazardous traffic location, an additive-saving operation or a shutting-down of the combustion engine is automatically prevented in order to be able to move the motor vehicle at least so far until safe shutting down is possible. The presence on a ferry or on a railway wagon for motor car transport can also be sensed in this connection. In addition, with a switched-off combustion engine, a restart is possible if required in order to transport the motor vehicle out of the hazard situation.

Alternatively or additionally, signals of a GPS system can be preferentially utilized. If it is detected that the motor vehicle is for example located on a road intersection, on a multi-lane freeway without parking bay, on a fill top or on a concealed entry, the switching-off of the combustion engine is likewise suppressed or a starting of the combustion engine permitted.

To evaluate the situation in which the vehicle is located, further sensors can supply the knowledge database with information. Practically, the knowledge database comprises current actual information regarding a speed and/or acceleration and/or rotational speed of the motor vehicle. Furthermore, in the case of a combustion engine that has been shut down because of a lack of additive reserve, the combustion engine can nevertheless be manually started or operated in normal mode with a small residual quantity. To this end, a switch is provided on an instrument panel for example. If the combustion engine was switched off automatically or it is operated in an economical operating state, this operating mode of the motor vehicle is indicated through the output of a visual and/or haptic and/or acoustic warning notice. Following this, the driver by actuating the switch can nevertheless operate the combustion engine in normal mode without additive in order to for example leave a potentially hazardous intersection region. The switch can also be designed as ignition starter switch and a renewed actuation of an ignition key establishes the explained switching state and the resultant operating state of the motor vehicle. Through the switch an activation of the control unit such that the combustion engine can be started, is also possible. Through this control, no regulations for the operation of motor vehicles with additives injected into an exhaust gas flow are bypassed but by means of the information of the sensors and/or of the knowledge database in connection with the switching position of the switch, merely a maneuvering out of a detected critical or hazardous situation made possible.

The changing into the additive-saving operation or the operation of the motor vehicle without additive can be stored in a control unit. It is possible, after a preset driving distance and/or a preset driving time, to output a visual and/or acoustic request for replenishing the additive. It is also conceivable to limit the maximum speed of the motor vehicle in this special situation, wherein upon automatic detection that said vehicle is travelling on a highway, the maximum speed corresponds to the reference speed so as not to constitute a traffic obstacle.

It is to be understood that the features mentioned above and still to be explained in the following cannot only be used in the respective combination stated, but also in other combinations. The scope is only defined by the claims.

### BRIEF DESCRIPTION OF THE DRAWINGS

The present invention will hereinafter be described in conjunction with the following drawing figures, wherein like numerals denote like elements and:

FIG. 1 a schematic representation of a motor vehicle; and

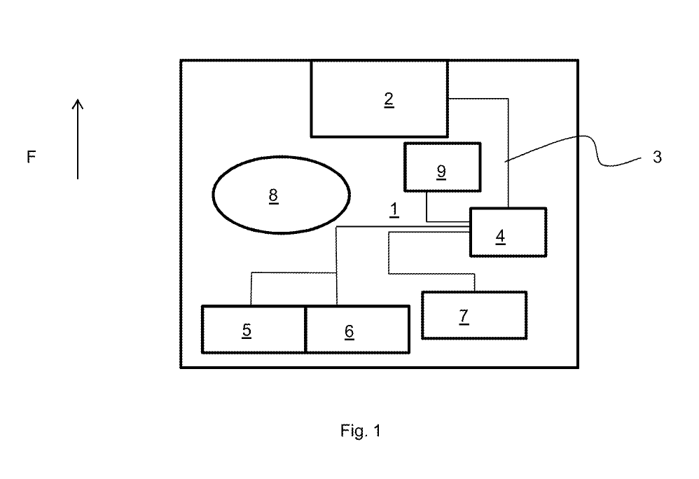

FIG. 2 is a block circuit diagram.

### DETAILED DESCRIPTION

The following detailed description is merely exemplary in nature and is not intended to limit application and uses. Furthermore, there is no intention to be bound by any theory presented in the receding background or the following detailed description.

The motor vehicle 1 travelling in the driving direction indicated by the arrow F is equipped with an image recording device 2, for example an optical chip camera, the signals of which are fed via connections 3 or data bus architectures to a control unit 4 of a driver assistance system, which for example optically monitors the environment of the motor vehicle 1 and which are processed by a knowledge database assigned to the control unit. Furthermore, the motor vehicle 1 comprises a combustion engine 5 the exhaust gas flow of which is supplied with an additive such as urea for the pollutant reduction from an additional tank 6. The combustion engine 5 and the additional tank 6 are only schematically hinted, in particular, no exhaust system, supply and discharge lines, injection devices, filling level sensors or the like are shown.

If for example it is detected by the control unit 4 that the filling level of the additive in the additional tank 6 is dropping below a reserve quantity or the additional tank 6 is completely empty, the combustion engine 5 is usually operated in an economical operating mode in order to reduce the consumption of the additive, or shut down entirely. However, the control unit 4, via the associated knowledge database via information stored in the knowledge database and current data made available to the knowledge database, also takes into account the signals of additional sensors, such as the image recording device 2 or a GPS system 7, during the operation of the combustion engine 5. If for example it is detected through the image processing and/or by means of the GPS system 7 that the motor vehicle 1 is located on a road intersection, in a concealed location, on a road without parking option or in an otherwise potentially hazardous traffic location it is possible to operate the combustion engine 5 with normal output in order to be able to reliably move the motor vehicle 1 out of this hazard situation. Subsequently, a start of the combustion engine 5 that is usually prevented because of a lack of additive is permitted so that the motor vehicle 1 can be maneuvered out of the critical or hazardous situation.

In addition, an additional or a multiply assigned switch 9 is provided for the driver 8 in order to bypass an economical operation or the shutting-down of the combustion engine 5 should such be required dependent on the situation. The multiply assigned switch 9 can more preferably be an ignition starter switch. The switching state of the switch 9 for bypassing the actually required economical operating state of the motor vehicle 1 or for an enforced starting of the combustion engine 5 can for example be stored in the control unit 4 and after a preset driving distance and/or a preset travelling time the driver 8 is requested to replenish the additive tank.

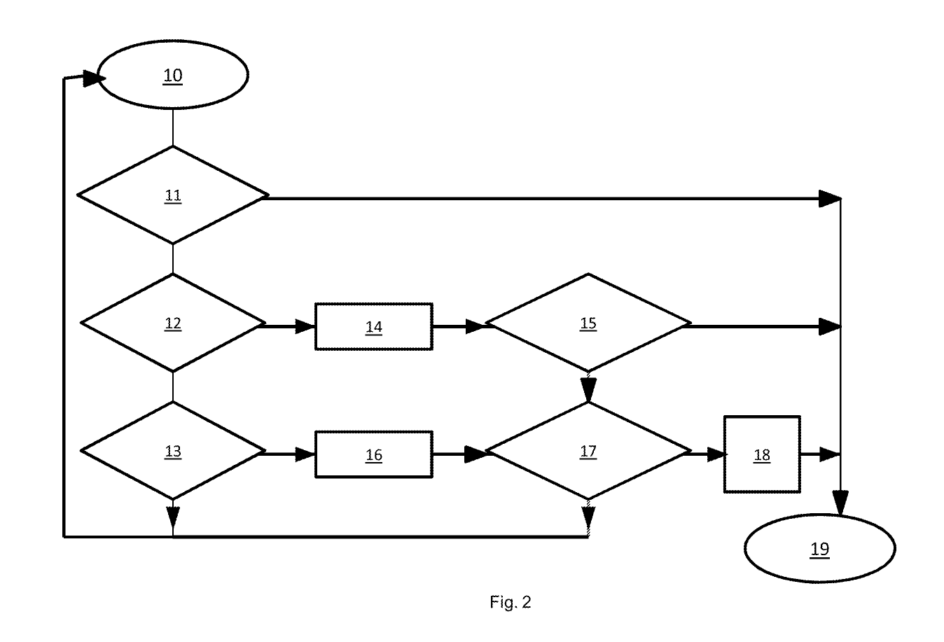

The method for operating the motor vehicle 1 is explained by means of the block diagram shown in FIG. 2 starting out from field 10, wherein the combustion engine 5 of the motor vehicle 1 is stopped and an engine start is to be effected. Initially, according to field 11, a sensor signal is queried in order to determine if the filling level of the additive in the additional tank 6 is adequate. If this is the case, a starting of the combustion engine 5 is permitted according to field 19. If the filling level of the additive in the additional tank 6 is not adequate, it is queried in field 12 if a reserve quantity of the additive is present in the additional tank 6. If this is the case, an evaluation of the knowledge database which is continuously updated while the control unit 4 is energized takes place according to field 14. The knowledge database is based on recognized patterns from sensor data and on criteria calculated from these. If based on the information present in the knowledge database the conclusion that the motor vehicle 1 is located in a critical situation whose determination criteria are obviously likewise stored in the knowledge database, is possible, a starting of the combustion engine 5 is permitted according to field 19. If a situation cannot be detected, a checking of the knowledge database to ascertain if there is a hazard situation or not is carried out according to field 17. If there is no hazard situation, no engine start takes place and a jump back to field 10 in the block diagram is performed, otherwise a starting of the combustion engine 5 is permitted according to field 19. If no reserve quantity of the additive is present in the additional tank 6 it is queried in field 13 if the motor vehicle is in an emergency situation. If this query is affirmed, the motor vehicle 1 thus is in such an emergency situation, an evaluation of the knowledge database is carried out according to field 16, according to which in field 17 the hazard situation can be determined or not. If neither an emergency situation nor a hazard situation can be determined, no engine start and in the block diagram a return jump to field 10 takes place. If the presence of a hazard situation is confirmed, functions restricting the operation of the motor vehicle 1 can be activated according to field 18 and after field 19 a starting of the combustion engine 5 permitted. The functions restricting the operation of the motor vehicle 1 can for example be a limitation of a maximum speed with which the motor vehicle can be operated with an empty additional tank 6.

While at least one exemplary embodiment has been resented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiments, it being understood that various changes may be made in the function and arrangement of elements described in an exemplary embodiment without departing from the scope set forth in the appended claims and their legal equivalents.

What is claimed is:

1. A motor vehicle with an exhaust gas retreatment system,
an additional tank configured to hold an additive;
a combustion engine configured to receive the additive that is injected into an exhaust gas flow of the combustion engine;
a sensor that is configured to monitor an environment of the motor vehicle;
a knowledge database configured to receive signals from the sensor; and
a control unit coupled to the knowledge database and configured to influence an operation of the motor vehicle as a function of a filling level of the additive in the additional tank and data of the knowledge database.

2. The motor vehicle according to claim 1, wherein the operation is an engine start.

3. The motor vehicle according to claim 1, wherein the sensor comprises an image recording device.

4. The motor vehicle according to claim 1, wherein the sensor comprises a GPS.

5. The motor vehicle according to claim 1, wherein the knowledge database comprises information regarding a speed of the motor vehicle.

6. The motor vehicle according to claim 1, wherein the knowledge database comprises information regarding an acceleration of the motor vehicle.

7. The motor vehicle according to claim 1, wherein the knowledge database comprises information regarding a rotational speed of the motor vehicle.

8. The motor vehicle according to claim 1,
further comprising a switch in an interior of the motor vehicle that is connected with the control unit,
wherein the combustion engine is configures to operate in a normal state upon actuation of the switch.

9. The motor vehicle according to claim 8, wherein a switching state of the switch is stored.

10. The motor vehicle according claim 1, further comprising a display device that is configured to visually display the influencing of the operation based on the filling level of the additive.

11. The motor vehicle according to any one of the claim 1, wherein a vehicle speed is limited as the function of the filling level of the additive.

12. The motor vehicle according to claim 1, wherein the control unit is configured to prevent a starting of the combustion engine as the function of the filling level of the additive.

13. A method for operating a motor vehicle with an exhaust gas retreatment system, comprising:
injecting an additive in an exhaust gas flow of a combustion engine;
receiving signals from a sensor configured to monitor an environment of the motor vehicle;
storing data corresponding to the signals from the sensor in a knowledge database; and
influencing an operation of the motor vehicle with a control unit as a function of a filling level in an additional tank for the additive and the data stored in the knowledge database.

14. The method according to claim 13, further comprising permitting an engine start when the filling level of the additive reaches a minimum level in the additional tank and the data stored in the knowledge database indicates a situation.

15. The method according to claim 13, further comprising permitting an engine start when the additive is not present in the additional tank and the data stored in the knowledge database indicates a situation.

16. The method according to claim 13, wherein the operation is an engine start.

17. The method according to claim 13, wherein the sensor comprises an image recording device.

18. The method according to claim 13, wherein the sensor comprises a GPS.

19. The method according to claim 13, wherein the knowledge database comprises information regarding a speed of the motor vehicle.

20. The method according to claim 13, wherein the knowledge database comprises information regarding an acceleration of the motor vehicle.
